(19) United States
(12) Patent Application Publication
(10) Pub. No.: US 2012/0068935 A1
(43) Pub. Date: Mar. 22, 2012

(54) INFORMATION INPUT DEVICE, CONTROL METHOD THEREOF AND IMAGE PROCESSING APPARATUS

(76) Inventors: Takeshi MUTOH, Osaka (JP); Kenji Itoh, Osaka (JP)

(21) Appl. No.: 13/237,995

(22) Filed: Sep. 21, 2011

(30) Foreign Application Priority Data
Sep. 22, 2010 (JP) 2010-212176(P)
Dec. 3, 2010 (JP) 2010-270523(P)

(51) Int. Cl. G06F 3/02

(52) U.S. Cl. 345/168

(57) ABSTRACT

An information input device includes a display unit that has a display screen and displays an image, and a touch-panel that is arranged on the display screen and specifies a designated position on the display screen. The display unit displays any of first, second and third screen images depending on the state of information input device, and the first and third screen images have a prescribed area on which information including the same character, sign or figure is displayed. If a position in the prescribed area is specified by an input unit while the first screen image is being displayed, the display unit displays the second screen image, and if a position in the prescribed area is specified while the third screen image is being displayed, the display unit maintains the display of the third screen image

### CROSS-REFERENCE TO RELATED APPLICATION

This nonprovisional application claims priority under 35 U.S.C. §119(a) on Patent Applications No. 2010-212176 filed in Japan on Sep. 22, 2010, and No. 2010-270523 filed in Japan on Dec. 3, 2010, the entire contents of which are hereby incorporated by reference.

### BACKGROUND OF THE INVENTION

1. Field of the Invention

The present invention relates to an information input device and an image processing apparatus and, more specifically, to an information input device having a function of making a transition to a special mode and to an image processing apparatus provided with the device.

2. Description of the Background Art

Conventionally, an operation panel having a transparent touch-panel arranged on a liquid crystal display panel is often used for facilitating operations and settings in image processing apparatuses such as multifunction peripherals. On the liquid crystal display panel, status is displayed on timely basis, and in accordance with the displayed contents, the touch-panel is operated, whereby an operation of the image processing apparatus can be set. By way of example, as shown in FIG. 1, an information input device 100 as an operation console causing the image processing apparatus to execute functions has been configured to include a display unit 102 and a number of hard keys.

Recently, however, it has been desired to reduce the size of operation panel, to increase the size of a display unit, and to allow operations by touching the display unit. For this, the operation console comes to be configured to include a few hard keys 112 and a display unit 114 including a touch panel, as represented by an information input device 110 shown in FIG. 2. In the example of FIG. 2, only two hard keys are provided, and the user makes various operations by touching display unit 114. For instance, if areas having indications of “COPY,” “FAX/IMAGE TRANSMISSION” and “DOCUMENT FILING” are touched, display is switched to screen images of the corresponding modes. On the switched-in screen image, a monochrome copy start key and a color copy start key are displayed.

Among the image processing apparatuses configured as described above, some have a special mode of which operation is not known to general users. In the special mode, a service person having special knowledge is allowed to set and adjust the image processing apparatus. In such an image processing apparatus, the special mode can be entered when the service person presses a pre-set combination of hard keys on the operation panel, or an authentication function is further provided and the special mode can be entered only if authentication with a prescribed password is successful. Such functions prevent easy change of settings of the image processing apparatus.

By way of example, Japanese Patent Laying-Open No. 2006-268623 (hereinafter referred to as '623 Reference) discloses a method of preventing easy change, in which on a virtual key used for inputting a password, a piece of information different from information allocated to the virtual key is displayed. FIG. 5 of '623 Reference shows an example in which a virtual key having the display of “key A” thereon is pressed if information “1” is to be input.

Easy entrance to the special mode screen image by casual operations of a general user must be prevented. With the configuration of operation panel changed from FIG. 1 to FIG. 2, the number of hard keys decreases and, therefore, measures for the prevention are indispensable.

Even if the authentication function with password is set, it is still difficult to attain sufficiently high security. It may be particularly problematic if the password is short, or of small digits. Though a longer password or increased number of digits attains higher security, input operation becomes troublesome, possibly resulting in erroneous inputs.

In the method disclosed in '623 Reference, to the virtual key indicated as “key A,” a prescribed piece of information is allocated. The indication (such as key A) of the virtual key and the allocated piece of information are not irrelevant but somewhat related. Further, the virtual key (such as key A) is displayed in such a manner that requests an input (for example, in a shape of an operation button). Therefore, it is highly likely that the password security is canceled by some operation by a general user and the special mode screen image is opened.

### SUMMARY OF THE INVENTION

In view of the above-described problem, it is desirable to provide an information input device and an image processing apparatus that can prevent, not by a special method but in a simple manner, easy change of the apparatus settings by a general user.

In the following, numbers of drawings in parentheses are inserted for easier understanding of the present invention, and not intended to limit the scope of the invention.

According to an aspect, the present invention provides an information input device that includes: a display unit that has a display screen and displays an image on the display screen; an input unit that is arranged on the display screen and specifies a designated position on the display screen; and a display control unit that controls the display unit to display any of first screen image (FIG. 7), second screen image (FIG. 9 or 10) and third screen image depending on a state of the information input device. The first and third screen images both have a prescribed area displaying information including the same character, sign or figure, displayed in a predetermined size at a predetermined position. The display unit displays the first or third screen image when a prescribed key is pressed. The display control unit controls the display unit to display the second screen image when a position in the prescribed area is specified by the input unit while the first screen image is being displayed, and maintains display of the third screen image when a position in the prescribed area is specified by the input unit while the third screen image is being displayed.

Preferably, the first and third screen images have identical appearance.

More preferably, the prescribed area does not include information representing the second screen image.

Further preferably, the information in the prescribed area includes at least one piece of information selected from the group consisting of year, month, date, day of the week and time.

Preferably, the information in the prescribed area includes information of at least one of temperature and humidity.

More preferably, the first screen image further includes information of at least one of character, sign and figure suggesting display of a fourth screen image (FIG. 8).

Further preferably, the information input device is connected to an image processing apparatus, and the fourth screen image is a screen image displaying information representing state of the image processing apparatus.

Preferably, the information input device is connected to an image processing apparatus, and the second screen image is a password input screen image, or a special image for setting or testing the image processing apparatus.

More preferably, the information input device is connected to an image processing apparatus. The second screen image is a password input screen image (FIG. 9). If authentication is successfully passed using the password input screen image, the display unit displays a special screen image (FIG. 10) for setting or testing the image processing apparatus.

Further preferably, information suggesting transition to the special screen image is not displayed in the prescribed area.

Preferably, the prescribed area is positioned at a corner of the first screen image.

More preferably, the display unit displays the first screen image when the prescribed key is pressed in a predetermined and prescribed manner. Further preferably, the prescribed manner is long-pressing the prescribed key, or successively pressing the prescribed key for a plurality of times.

Preferably, when the prescribed key is pressed in a first manner of pressing, the display unit displays the first screen image; and when the prescribed key is pressed in a second manner of pressing different from the first manner of pressing, the display unit displays the third screen image.

More preferably, the first manner of pressing is either one of long-pressing and successive pressing of successively pressing the same key for a plurality of times; and the second manner of pressing is the other one of the long-pressing and the successive pressing.

Further preferably, the prescribed key is a hard key provided separate from the input unit, or a soft key configured by a partial image displayed on the display unit and that area of the input unit which corresponds to the partial image.

Preferably, the prescribed key is a hard key provided separate from the input unit; and the display unit displays the first screen image only while the prescribed key is long-pressed.

More preferably, the information input device described above is connected to an image processing apparatus and further includes an operation unit receiving an input by a user operating the image processing apparatus. The input unit and the prescribed key constitute the operation unit. The input unit may be a touch-panel, and the prescribed key may be a hard key.

The image processing apparatus in accordance with the present invention includes the information input device as described above, and receives a user operation through the information input device.

According to another aspect, the present invention provides a method of controlling an information input device that includes a display unit that has a display screen and displays an image on the display screen, and an input unit that is arranged on the display screen and specifies a designated position on the display screen, including the steps of: controlling the display unit to display any of first, second and third screen images depending on state of the information input device; and displaying the first or third screen image when a prescribed key is pressed; wherein the first and third screen images both have a prescribed area displaying information including the same character, sign or figure, displayed in a predetermined size at a predetermined position; the method further includes the steps of: displaying the second screen image when a position in the prescribed area is specified by the input unit while the first screen image is being displayed; and maintaining display of the third screen image when a position in the prescribed area is specified by the input unit while the third screen image is being displayed.

According to the present invention, it becomes possible to reduce the possibility of a general user inadvertently or wrongly activating the special mode, and thereby to prevent easy change of settings of the image processing apparatus by the general user.

Since the present invention can be implemented using only the information input device including the operation panel and the display panel commonly provided on the image processing apparatus by changing the control program, easy change of settings of the image processing apparatus can be prevented in a simple manner, not necessitating use of a special method.

Since the password entering screen image is displayed before displaying the special screen image, easy change of settings of the image processing apparatus can more reliably be prevented.

Further, the special mode activating function on the first screen image is enabled/disabled in accordance with the manner of pressing the key as a trigger for displaying the first screen image to enter the special mode and, therefore, easy change of settings of the image processing apparatus can more reliably be prevented.

Further, every time the first screen image is displayed, the positions where the plurality of prescribed areas are displayed in the first screen image are changed. Therefore, easy change of settings of the image processing apparatus can more reliably be prevented.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view showing an information input device provided on a conventional image processing apparatus.

FIG. 2 is a plan view showing an information input device with a few hard keys.

FIG. 3 is a perspective view showing an appearance of the image processing apparatus in accordance with an embodiment of the present invention.

FIG. 4 is a functional block diagram showing hardware configuration of the image processing apparatus shown in FIG. 3.

FIG. 5 is a plan view showing an information input device provided on the image processing apparatus shown in FIG. 3.

FIG. 6 shows an exemplary screen image displayed when a program key is pressed in a normal manner in the information input device shown in FIG. 5.

FIG. 7 shows an exemplary screen image displayed when the program key is pressed in a manner different from the normal manner in the information input device shown in FIG. 5.

FIG. 8 shows an exemplary screen image displayed when an area of “display total number of sheets used” on the screen image shown in FIG. 7 is pressed.

FIG. 9 shows an exemplary screen image displayed when a prescribed area on the screen image shown in FIG. 7 is pressed.

FIG. 10 shows an example of special screen image.

FIG. 11 shows an exemplary screen image displayed when “001” is input on the special screen image shown in FIG. 10.

FIG. 12 shows an exemplary screen image displayed when “002” is input on the special screen image shown in FIG. 10.

FIG. 13 is a flowchart representing a control structure of a program for realizing a process to make a transition to the special mode in the image processing apparatus in accordance with an embodiment of the present invention.

FIG. 14 is a flowchart representing a control structure of a program for realizing a process not to make a transition to the special mode in the image processing apparatus in accordance with an embodiment of the present invention.

FIG. 15 is a flowchart representing a control structure of another program for realizing a process to make a transition to the special mode in the image processing apparatus in accordance with an embodiment of the present invention.

FIG. 16 shows another exemplary screen image displayed when the program key is pressed in a manner different from the normal manner.

FIG. 17 shows still another exemplary screen image displayed when the program key is pressed in a manner different from the normal manner, in which arrangement of crosses at screen corners is different from FIG. 16.

FIG. 18 is a flowchart representing a control structure of a program for realizing a process to make a transition to the special mode through the screen image shown in FIG. 16 or 17.

FIG. 19 is a flowchart representing a control structure of a program for realizing “process for other key” of the flowchart shown in FIG. 18.

FIG. 20 shows a still another exemplary screen image displayed when the program key is pressed in a manner different from the normal manner.

FIG. 21 shows a still another exemplary screen image displayed when the program key is pressed in a manner different from the normal manner, in which arrangement of RGB at screen corners is different from FIG. 20.

FIG. 22 is a flowchart representing a control structure of a program for realizing a process to make a transition to the special mode through the screen image shown in FIG. 20 or 21.

FIG. 23 is a flowchart representing a control structure of a program for realizing “process for other key” of the flowchart shown in FIG. 22.

FIG. 24 is a flowchart representing a control structure of a program for realizing “special mode entering process” of the flowchart shown in FIG. 22.

FIG. 25 is a flowchart representing a control structure of a program for realizing a process when the program key is long-pressed.

FIGS. 26 to 30 show examples of screen images displayed when the program key is pressed in a manner different from the normal manner, in the information input device shown in FIG. 5.

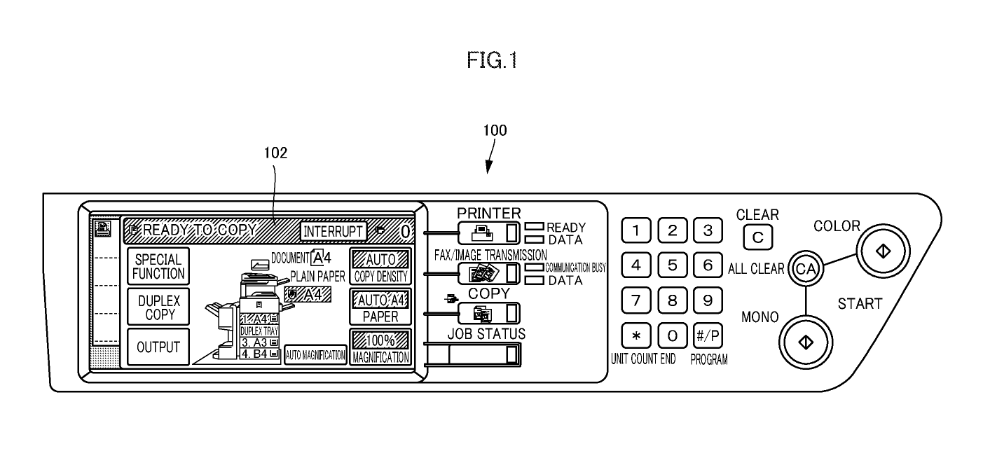

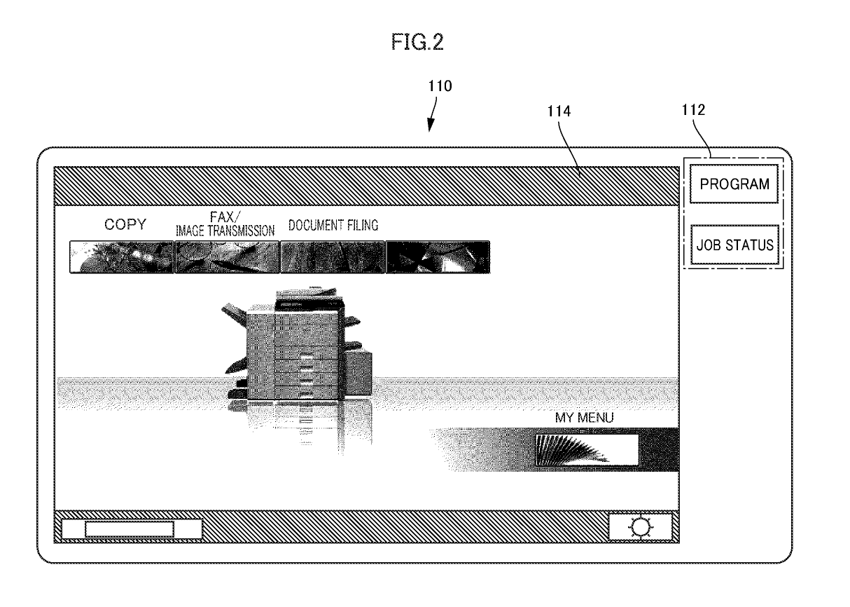

### DESCRIPTION OF THE PREFERRED EMBODIMENTS

In the following description and in the drawings, the same components are denoted by the same reference characters. Their names and functions are also the same. Therefore, detailed description thereof will not be repeated.

In the following, embodiments of the present invention will be described specifically with reference to the appended figures.

<Image Processing Apparatus>

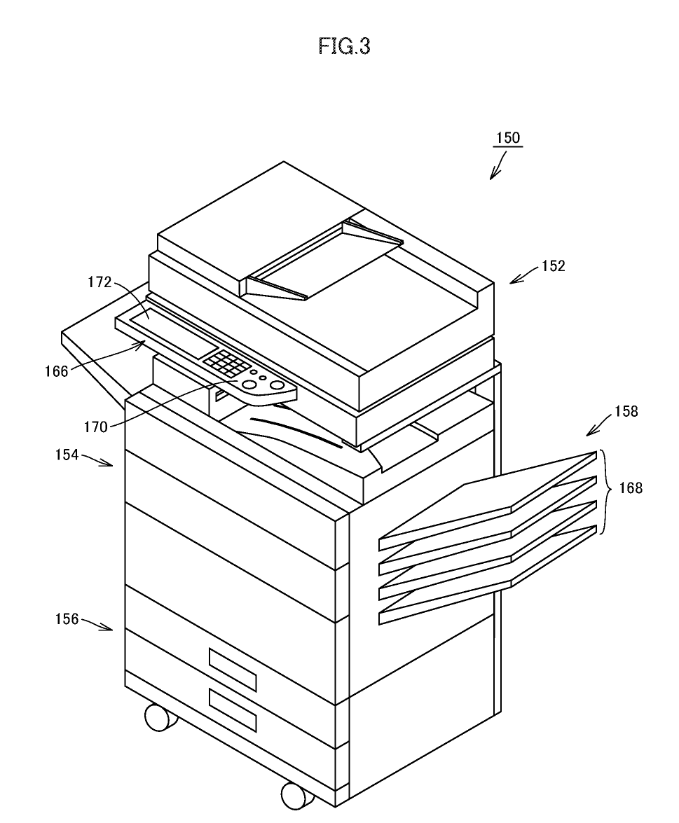

Referring to FIG. 3, an image processing apparatus 150 in accordance with an embodiment of the present invention includes a document reading unit 152, an image forming unit 154, a paper feed unit 156, a paper discharging device 158 having a paper discharge tray 168, and an information input device 166. Information input device 166 is an operation console causing image processing apparatus 150 to execute prescribed functions, and allows various settings related to image processing apparatus 150. Information input device 166 has an operation panel 170 and a display panel 172.

<Hardware Block>

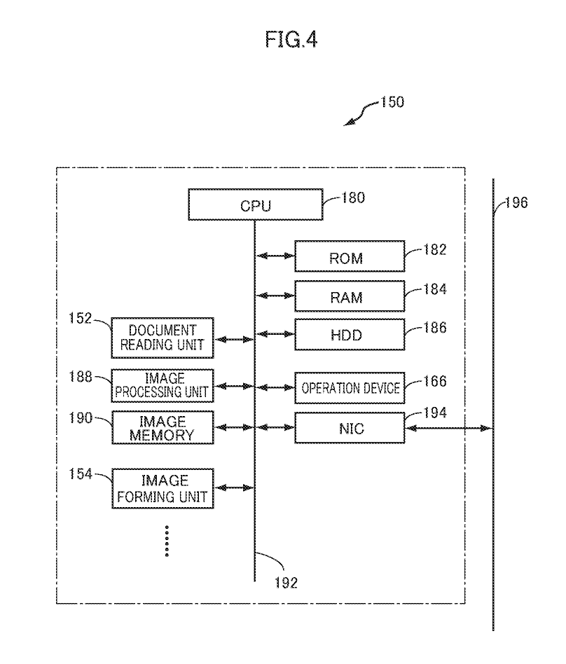

Referring to FIG. 4, image processing apparatus 150 includes therein a CPU (Central Processing Unit) 180, an ROM (Read Only Memory) 182, an RAM (Random Access Memory) 184, and an HDD (Hard Disk Drive) 186. CPU 180 assumes overall control of image processing apparatus 150. ROM 182 stores a program or programs. RAM 184 is a volatile storage. HDD 186 is a non-volatile storage that retains data even when power supply is shut off. ROM 182 stores program and data necessary for controlling operations of image processing apparatus 150.

Image processing apparatus 150 further includes an image processing unit 188, an image memory 190, a bus 192 and an NIC (Network Interface Card) 194. CPU 180, ROM 182, RAM 184, HDD 186, information input device 166, NIC 194, document reading unit 152, image processing unit 188, image memory 190, image forming unit 154 and the like are connected to bus 192. Data (including control information) is exchanged among these units through bus 192. CPU 180 reads a program from ROM 182 through bus 192 to RAM 184, and executes the program using a part of RAM 184 as a work area. Specifically, CPU 180 controls various units forming image processing apparatus 150 in accordance with the program stored in ROM 182 and realizes various functions of image processing apparatus 150. NIC 194 is connected to an external network 196, and it serves as an interface for communication through network 196. General functions of image processing apparatus 150 are well known as disclosed, for example, in Japanese Patent Laying-Open No. 2010-169738 and, therefore, detailed description thereof will not be repeated here.

<Information Input Device>

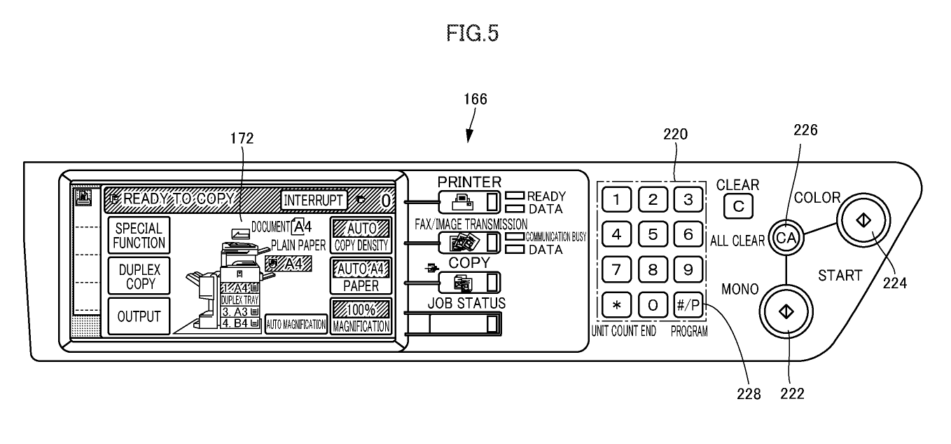

Referring to FIG. 5, information input device 166 is integrally formed of operation panel 170 and display panel 172. Specifically, operation panel 170 includes ten keys 220, a program key 228, start keys (a monochrome print start key 222 and color print start key 224) for instructing start of a print process, an all-clear key 226 and other operation keys. These keys are arranged on a right side area of information input device 166. On the contrary, display panel 172 is arranged on the left side area of information input device 166. Display panel 172 is formed by superposing a touch-panel on a display device such as a liquid crystal display. On display panel 172 shown in FIG. 5, a standby screen image is displayed. In the present specification, the screen image means an image displayed on a display screen such as the liquid crystal display.

Information input device 166 allows, by the display on display panel 172, confirmation of the state of image processing apparatus 150 and current status of job processing. By selecting selection keys displayed on the display screen of display panel 172, using the touch-panel superposed on the display screen (by pressing the corresponding portions on the touch-panel), functions of image processing apparatus 150 can be set and operations of image processing apparatus 150 can be instructed.

In a device having a liquid crystal display or the like and a touch-panel arranged thereon, whether a displayed selection key is pressed or not can be determined using known technique. By way of example, correspondence between two-dimensional coordinates of the touch-panel and two-dimensional coordinates of the liquid crystal display is determined in advance, and whether or not a position pressed on the touch-panel is included in an area of a character or figure displayed on the liquid crystal display is determined. A “key” on display panel 172 means an area of displayed figure or a prescribed area including the figure, as well as a portion of the touch-panel superposed on such area.

### First Embodiment

In the following, a first embodiment for displaying a screen image allowing transition to the special mode in image processing apparatus 150 will be described.

<Exemplary Screen Images on Display Panel>

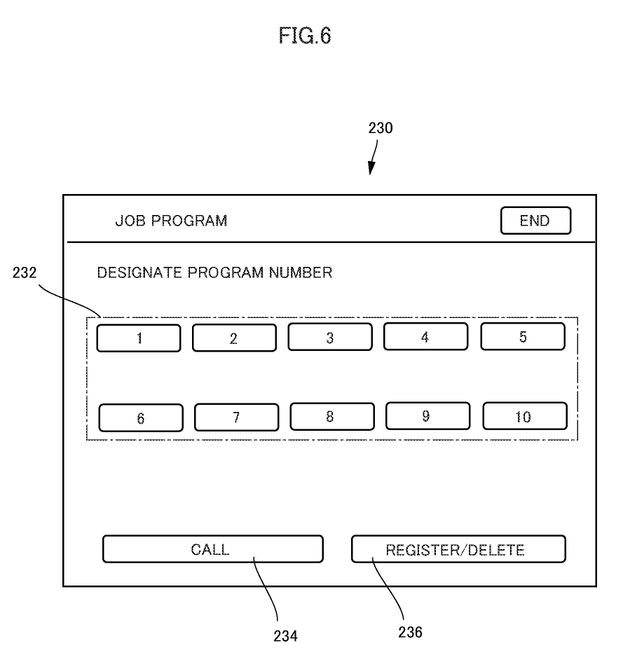

FIG. 6 shows an exemplary screen image displayed on display panel 172, when program key 228 of information input device 166 shown in FIG. 5 is pressed in a normal manner, that is, pressed once for a period shorter than a prescribed time period (for example, shorter than 2 seconds). A job program screen image shown in FIG. 6 is a screen image for registering settings of various copy conditions as job programs and for calling any of the jobs for use. By pressing a call key 234 and pressing a number key for which the job program is registered among the number keys, the corresponding program is called. By pressing a register/delete key 236 and pressing a number key for which a new job program is to be registered, a screen image for setting copy conditions is displayed.

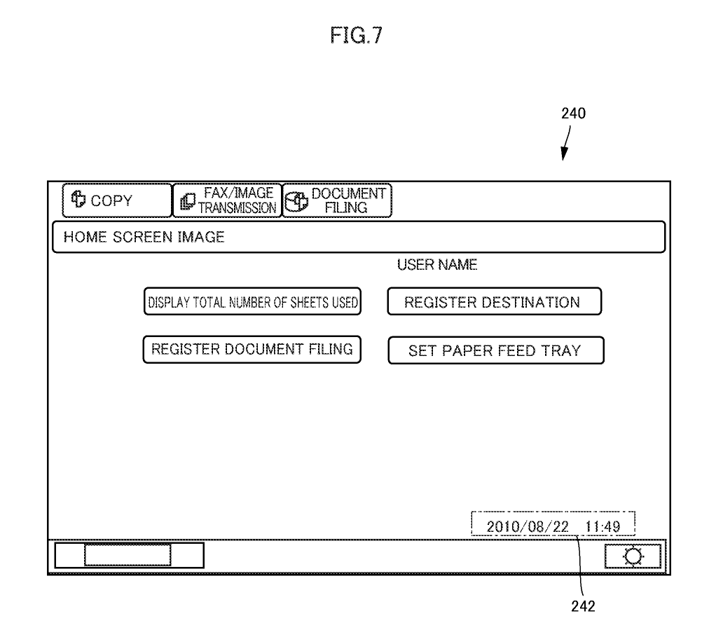

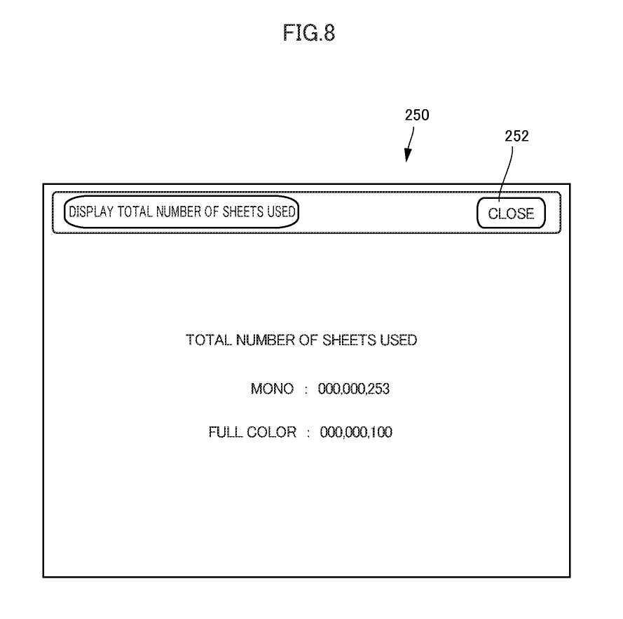

FIG. 7 shows an exemplary screen image displayed on display panel 172, when program key 228 of information input device 166 shown in FIG. 5 is pressed in a manner different from the normal manner. The manner of pressing different from the normal manner may include double-click (successively pressing the same key twice with a prescribed short time interval) and long-press (pressing and holding for a prescribed time or more, for example, keeping the key pressed for 2 seconds or longer). By using screen image 240 shown in FIG. 7, it is possible for the user to display and set the state of image processing apparatus 150. Specifically, if the area with indications of “display total number of sheets used,” “register destination,” “register document filing” or “set paper feed tray” is pressed, a screen image for displaying or setting the corresponding information is displayed. If the area with the indication “display total number of sheets used” is pressed, the screen image of FIG. 8 appears.

For example, on a screen image 250 shown in FIG. 8, the total number of sheets used, as consumables, is displayed. It can be seen that the number of sheets used for monochrome printing was 253, and the number of sheets used for full color printing was 100. When CLOSE key 252 at the upper right side is pressed, screen image 240 of FIG. 7 is resumed.

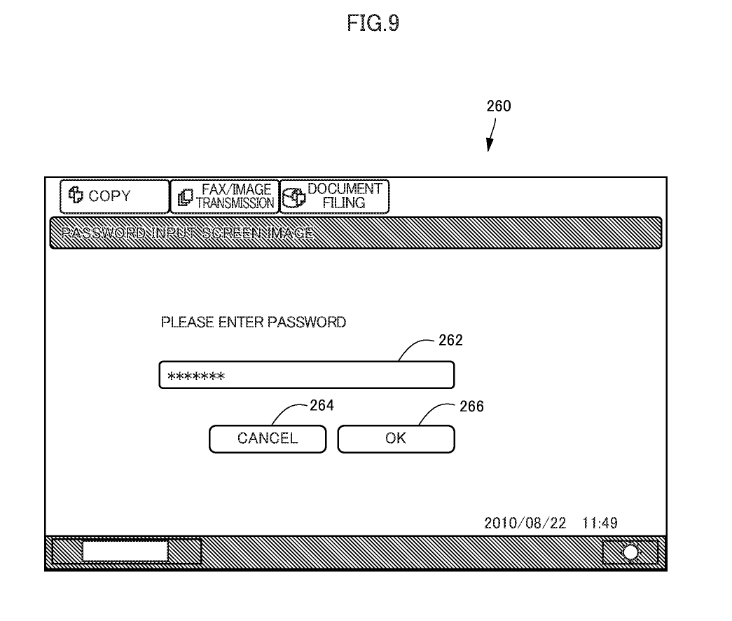

FIG. 9 shows a password input screen image 260 displayed when an area (hereinafter referred to as date and time display area) 242, on which year, month and date as well as time are displayed at the lower right portion of screen image 240 shown in FIG. 7, is touched. By way of example, when ten keys 220 are operated, symbols (*) representing inputs are displayed on password entering area 262. When a correct password is input and an OK key 266 is pressed, image processing apparatus 150 enters the special mode, and a special screen image is displayed. If a cancel key 264 is pressed, the standby screen image (see FIG. 5) is displayed.

On screen image 240 shown in FIG. 7, if the area with indications of “display total number of sheets used,” “register destination,” “register document filing” or “set paper feed tray” is pressed, the corresponding screen image is displayed. The date and time display area, invoking display of the password input screen image 260 when pressed, is provided on this screen image from the following reason. Typically, when the screen image of FIG. 7 is displayed, the user pays attention to the “display total number of sheets used,” “register destination,” “register document filing” or “set paper feed tray” key, which is selectable. Therefore, the display of characters (year, month, date and time) of date and time display area 242 is hardly noticed by the user. Therefore, the user will not readily touch the characters on date and time display area 242 and, hence, easy entrance to the special mode can be prevented.

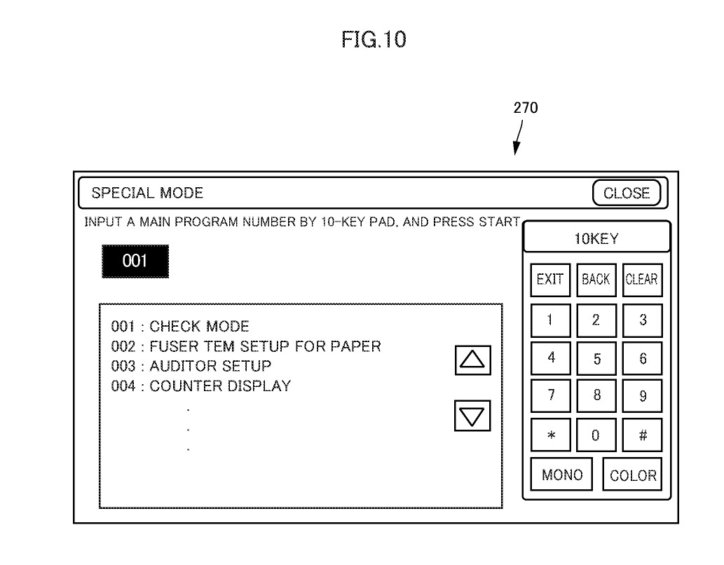

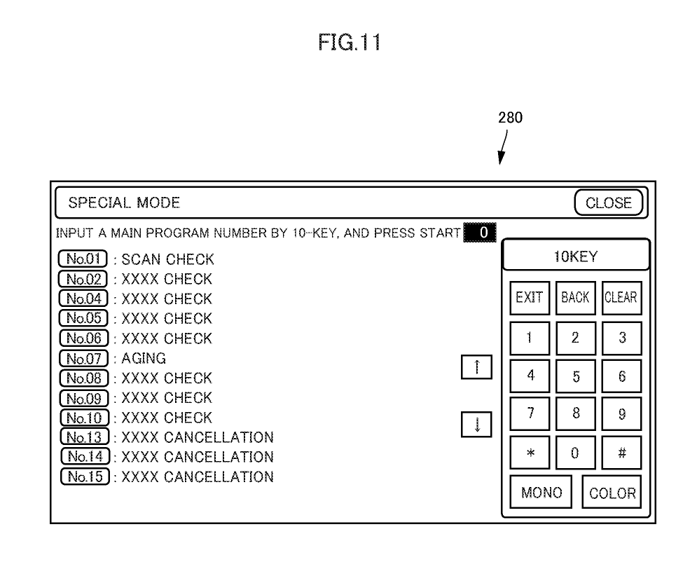

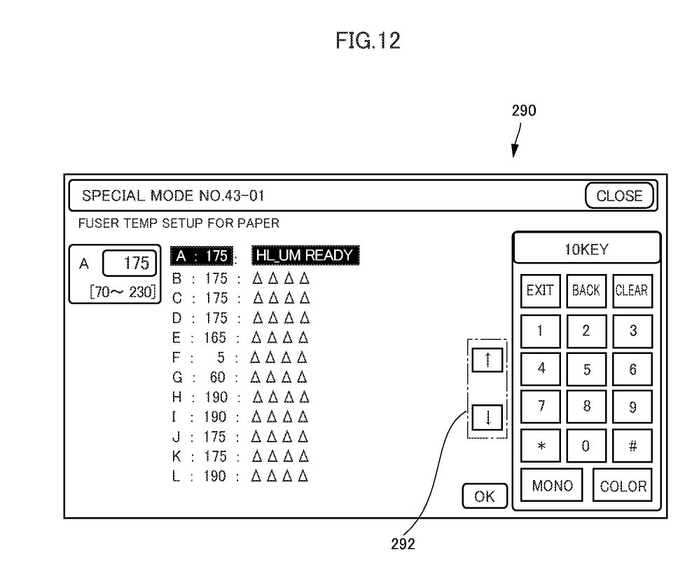

The special screen image is used by an authorized person such as a service person to make and adjust settings of image processing apparatus 150. The contents of settings and adjustment are appropriately determined in accordance with functions of image processing apparatus 150, as can be readily understood by those skilled in the art. For instance, on special screen image 270 shown in FIG. 10, setting items or test items are displayed in a list with three-digit numbers at the head. The setting item or the like is designated, for example, by ten keys displayed on the right side. At an upper left portion of FIG. 10, “001” input by the ten keys are displayed in highlight. If “001” is input, the screen image of FIG. 11 is displayed, and if “002” is input, the screen image of FIG. 12 is displayed.

Screen image 280 shown in FIG. 11 is a selection screen image for executing test mode. On the left side of screen image 280, various test modes are displayed with numbers in a list. For example, No. 01 indicates a scanner test mode, and if “1” of the ten keys on the right side of the screen image is pressed, the scanner test mode is executed. In the scanner test mode, when a copy key is pressed, a light source unit moves over and scans a document. In this mode, whether or not the light source is successfully turned on, whether or not the light source unit moves successfully with the light on (going) and whether or not the light source unit moves successfully with the light off (returning) are tested.

FIG. 12 shows an exemplary screen image for setting parameters of image processing apparatus 150. A screen image 290 shown in FIG. 12 is a setting screen image related to a fixing unit. Setting items are displayed with alphabets in a list. FIG. 12 shows a state in which a line starting from the letter A is selected by an up/down key 292 and the selected line is highlighted. In this state, if “175” is input by the ten keys displayed on the right side of the screen image and OK key is pressed, the value is set. The line starting from the letter A is for setting the temperature of a heater lamp, and the displayed value “175” indicates the temperature.

<First Software Configuration>

In the following, a process for displaying the special screen image when information input device 166 is operated will be described. In the following, various processes are realized by CPU 180 executing programs read from ROM 182. Further, in the following, that a prescribed area of the screen image displayed on display panel 172 is pressed means that the corresponding portion of the touch-panel is pressed.

Here, it is assumed that whether the function to make a transition to the special mode (hereinafter referred to as special mode entering function) is to be enabled or disabled when the first screen image is displayed is determined by the manner of pressing program key 228. Specifically, when program key 228 is double-clicked, the special mode entering function is enabled, and when the key is long-pressed, the special mode entering function is disabled.

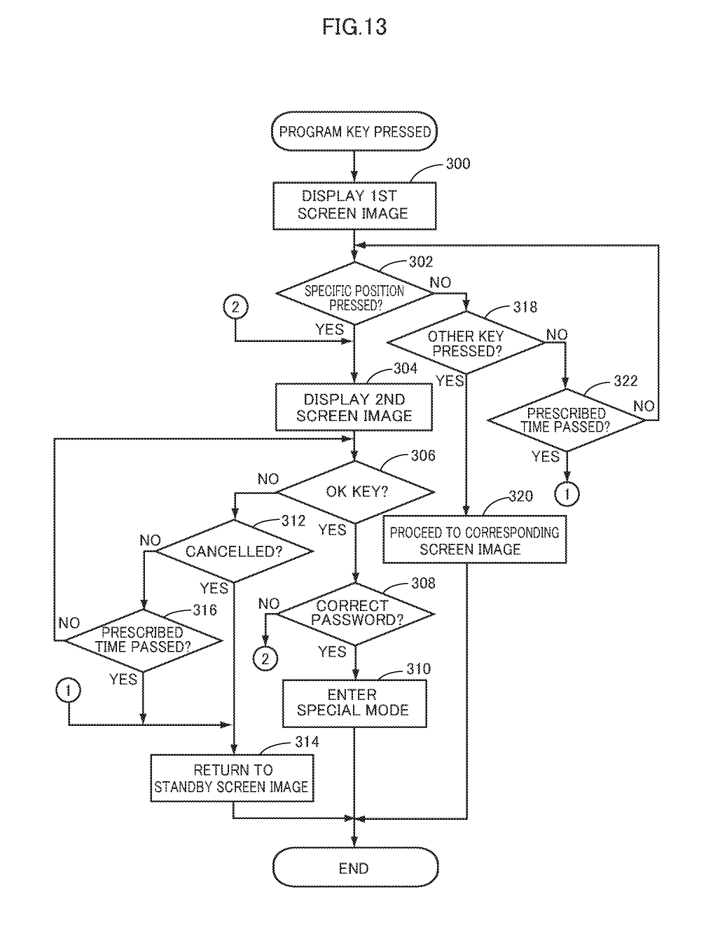

Referring to FIG. 13, assume that program key 228 is pressed in a manner different from the normal manner or, specifically, double-clicked. Then, at step 300 of the program for realizing the process for displaying the special screen image, CPU 180 displays a first screen image on display panel 172. The first screen image is, for example, screen image 240 shown in FIG. 7. Since the key has been double-clicked, the special mode entering function is enabled. Here, in order to resume the standby screen image (see FIG. 5) if the display of screen image continues for a prescribed time period or longer as will be described later, CPU 180 obtains the current time from a timer and sets the time as a start time (for example, stores the current time in a prescribed area secured in advance in RAM 184).

At step 302, CPU 180 determines whether or not a predetermined specific position on the first screen image is pressed. The specific position is, for example, the date and time display area 242 of FIG. 7. If the specific position is pressed, the control proceeds to step 304 and if not, the control proceeds to step 318.

At step 318, CPU 180 determines whether or not any other key at a position other than the specific position is pressed. Other keys include, in the example of FIG. 7, the keys having indications “display total number of sheets used,” “register destination,” “register document filing” and “set paper feed tray” (hereinafter these keys are also referred to as function keys). If any other key is pressed, the control proceeds to step 320, at which CPU 180 displays the corresponding screen image and executes a prescribed process, and the present program ends. If no other key is pressed, the control proceeds to step 322.

At step 322, CPU 180 obtains the current time, and calculates the elapsed time from the start time set at step 300. CPU 180 determines whether or not the calculated elapsed time is equal to or longer than a preset reference time. If it is equal to or longer than the reference time, the control proceeds to step 314. At step 314, CPU 180 displays standby screen image, and the present program ends. If it is shorter than the reference time, the control returns to step 302. Therefore, if a prescribed time period (reference time) passes without any effective operation on display panel 172 after the first screen image is displayed, the screen image display on display panel 172 returns to the initial screen image (standby screen image).

At step 304, CPU 180 displays a second screen image, obtains the current time from the timer and sets the time as the start time (for example, overwrites the prescribed area of RAM 184 at which the start time was stored at step 300), and the control proceeds to step 306. The second screen image is password input screen image 260 shown in FIG. 9.

At step 306, CPU 180 determines whether or not OK key 266 is pressed. If OK key 266 is pressed, the control proceeds to step 308. If OK key 266 is not pressed, the control proceeds to step 312.

At step 308, CPU 180 determines whether or not a correct password is input. If the password is correct, at step 310, image processing apparatus 150 enters the special mode. Specifically, CPU 180 displays the special screen image on display panel 172 and activates the program for the special mode, and terminates the present program. If the password is not correct, the control returns to step 304, and CPU 180 again receives a password input. At the time when the control returns to step 304, CPU 180 displays, for example, a message that the password is not correct.

At step 312, CPU 180 determines whether or not cancel key 264 is pressed. If cancel key 264 is pressed, the control proceeds to step 314 at which CPU 180 displays the standby screen image, and the present program ends. If cancel key 264 is not pressed, the control proceeds to step 316. At step 316, CPU 180 calculates the elapsed time from the start time set at step 304 in the similar manner as at step 322, and determines whether or not a prescribed time period has passed. If the prescribed time has not yet passed, the control returns to step 306. If the prescribed time has passed, the control returns to step 314, at which CPU 180 displays the standby screen image, and the present program ends.

Through the above-described process, the second screen image allowing transition to the special mode can be displayed only if a specific position of the first screen image, which appears when program key 228 of information input device 166 is pressed in a manner different from the normal manner, that is, only when the key is double-clicked, is pressed. Therefore, if the specific position is set at an area of which display is generally not regarded as a key, it is possible to prevent a general user from easily entering the special mode. As described above, it is very unlikely that the second screen image is easily displayed. In addition, the displayed second screen image is the password input screen image. Therefore, possibility of easily allowing entrance to the special mode can significantly be reduced as compared with the conventional art.

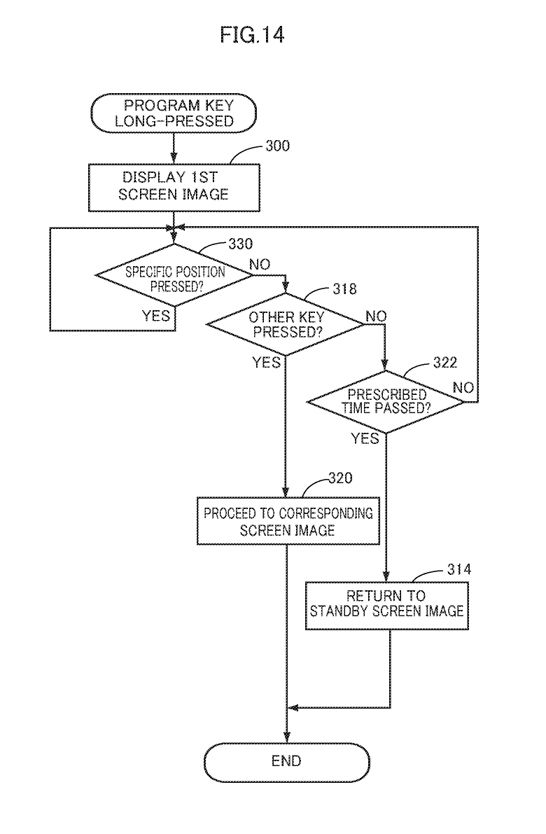

Next, referring to FIG. 14, the control structure of a program for realizing the process when program key 228 is long-pressed will be described. In the flowchart of FIG. 14, the processes at steps 300, 314, 318, 320 and 322 other than step 330 are the same as the processes of steps of the same number in FIG. 13. Since the key is long-pressed, the special mode entering function is disabled, as realized by step 330. Here, step 330 only will be described, and description of other steps will not be repeated.

At step 330, CPU 180 determines whether or not a predetermined, specific position on the first screen image is pressed. The specific position is, for example, date and time display area 242 shown in FIG. 7. If the specific position is pressed, CPU 180 again makes the determination at step 330 without any other operation. If the specific position is not pressed, the control proceeds to step 318.

As described above, if program key 228 of information input device 166 is long-pressed, even if the specific position of the displayed first screen image is pressed, the screen image is kept displayed as it is, and the second screen image allowing transition to the special mode is not displayed. Therefore, easy entrance to the special mode by a general user can more reliably be prevented.

The screen image displayed when the key is long-pressed is the same screen image as the first screen image in which the special mode entering function is enabled. The screen, however, may be considered to be a third screen image, since the special mode entering function is disabled.

In the foregoing, an example has been described in which the special mode entering function is enabled if program key 228 is double-clicked and the special mode entering function is disabled if program key is long-pressed. The example above, however, is not limiting. The conditions for enabling/disabling the special mode entering function may be reversed. Further, the manner of pressing different from the normal manner may be any manner of pressing other than double-click and long-press.

Further if the first screen image is displayed, the special mode entering function may always be enabled, regardless of the manner of pressing program key 228.

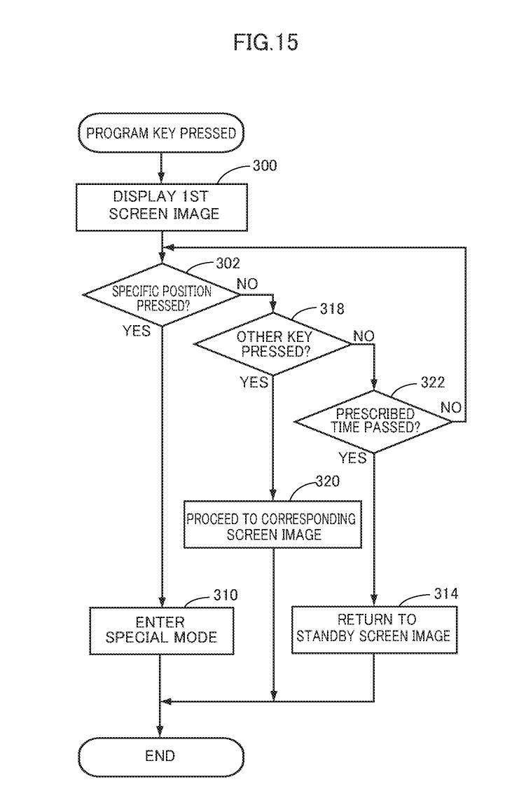

In the foregoing, an example has been described in which password input screen image 260 is displayed as the second screen image. The example above, however, is not limiting. For instance, the special screen image may be directly displayed as the second screen image, as shown in the flowchart of FIG. 15. Steps shown in FIG. 15 are the same as those having the same numbers in FIG. 13. Therefore, description thereof will not be repeated.

In the foregoing, an example has been described in which the first screen image is displayed if program key 228 is pressed in a manner different from the normal manner. The example above, however, is not limiting. The first screen image may be displayed if a different key is pressed. If the different key does not have any function allocated thereto, the first screen image may be displayed simply if the key is pressed. If the different key has any function allocated thereto, the first screen image may be displayed if the key is pressed in a manner different from the normal manner.

### Second Embodiment

A second embodiment for displaying a screen image for entering the special mode in image processing apparatus 150 will be described in the following.

<Exemplary Screen Image Display on Display Panel>

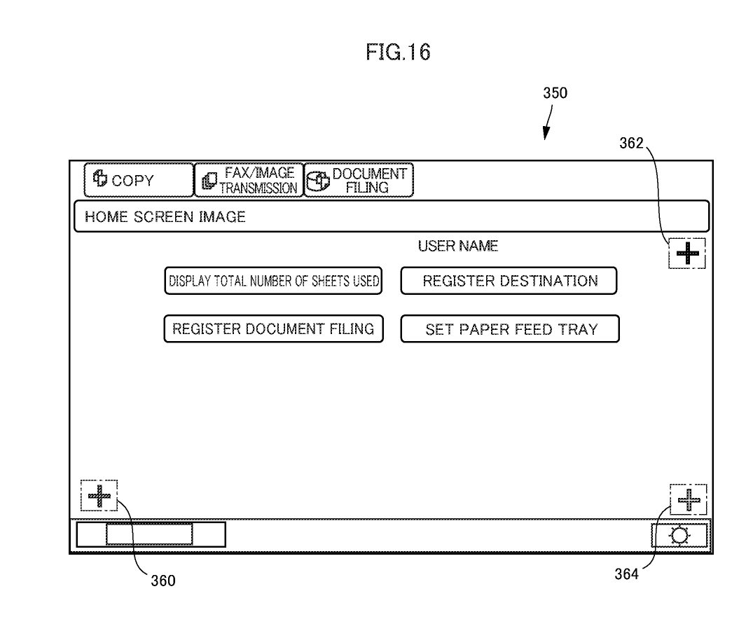

FIG. 16 shows a second example of the screen image displayed on display panel 172 when program key 228 is pressed in a manner different from the normal manner, in information input device 166 shown in FIG. 5. Though a screen image 350 of FIG. 16 is similar to screen image 240 shown in FIG. 7, in place of date and time, crosses are shown at three corners. Function keys such as “display total number of sheets used” shown in FIG. 16 are the same as those of FIG. 7 and, therefore, description thereof will not be repeated.

The crosses displayed at the corners of screen image 350 have the same shape but different colors. By way of example, the cross at the lower left corner is red, the cross at the upper right corner is green and the cross at the lower right corner is blue. The special screen image is displayed and the special mode is entered, only when the areas where the crosses of three colors (hereinafter referred to as red cross key 360, green cross key 362 and blue cross key 364) are pressed successively in a prescribed order.

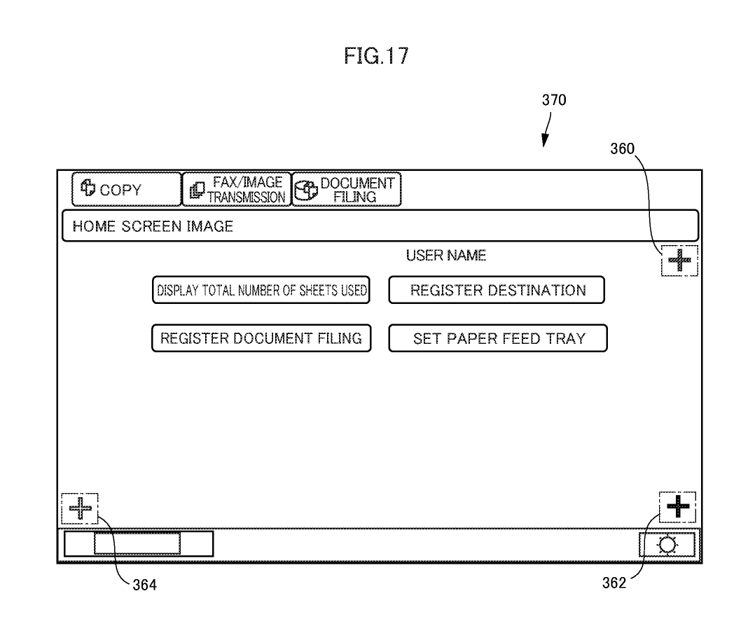

FIG. 17 shows a screen image 370 displayed on display panel 172 when program key 228 is pressed in a manner different from the normal manner. Though screen image 370 is similar to screen image 350 shown in FIG. 16, the arrangement of three cross keys of different colors displayed at three portions is different from that of FIG. 16. In FIG. 17, blue cross key 364 is shown at the lower left corner, red cross key 360 is shown at the upper right corner, and green cross key 362 is shown at the lower right corner. As in FIG. 16, the special mode is entered only when these cross keys are pressed successively in a prescribed order.

When program key 228 is pressed, the same screen image may be displayed. In the present embodiment, however, the arrangement of three cross keys of different colors is changed in accordance with the situation of pressing the program key 228 (for example, date and time of pressing), or at random. In that case also, the conditions for entering the special mode, that is, the order in which the cross keys of three colors are to be pressed successively, are kept unchanged.

<Second Software Configuration>

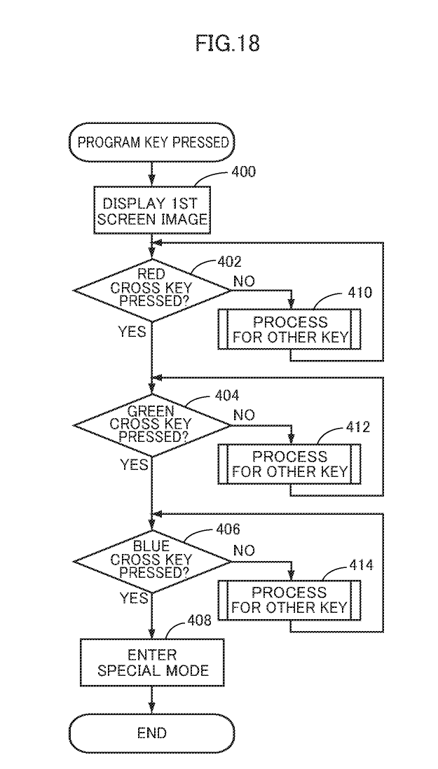

Referring to FIG. 18, when program key 228 is pressed in a manner different from the normal manner, at step 400 of the program for realizing the process for displaying the special screen image, CPU 180 displays the first screen image on display panel 172. The first screen image is screen image 350 or 370 shown in FIG. 16 or 17. Here, in order to resume the standby screen image (see FIG. 5) if the display of screen image continues for a prescribed time period or longer as will be described later, CPU 180 obtains the current time from a timer and sets the time as a start time (for example, stores the current time in a prescribed area secured in advance in RAM 184).

At step 402, CPU 180 determines whether or not red cross key 360 is pressed. If red cross key 360 is pressed, CPU 180 obtains the current time from the timer and sets the time as the start time (for example, overwrites the prescribed area of RAM 184 where the start time was stored at step 400). Thereafter, the control proceeds to step 404. If red cross key 360 is not pressed, the control proceeds to step 410.

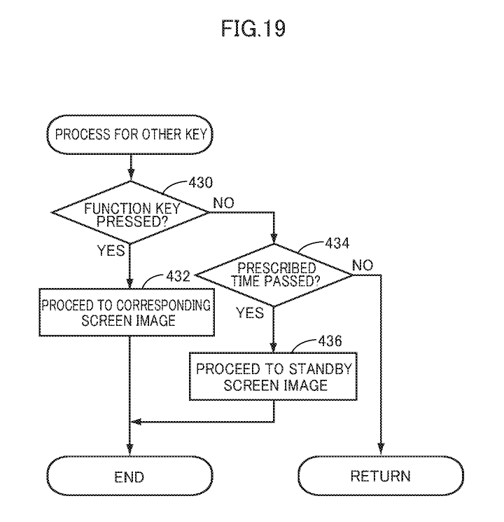

The process at step 410 is as shown in FIG. 19. Specifically, at step 430, CPU 180 determines whether or not any of the function keys (see FIGS. 16 and 17) displayed on display panel 172 is pressed. If any of the function keys is pressed, at step 432, CPU 180 displays a screen image corresponding to the pressed key, and the present program ends. If none of the function keys is pressed, at step 434, CPU 180 obtains the current time, and calculates the elapsed time from the start time set at step 400. CPU 180 determines whether or not the calculated elapsed time is equal to or longer than a preset reference time. If it is equal to or longer than the reference time, the control proceeds to step 436, at which CPU 180 displays the standby screen image, and the present program ends. If it is shorter than the reference time, the control returns to step 402. Therefore, CPU 180 waits for a next key operation for a prescribed time period (reference time) after the first screen image is displayed. If the prescribed time period passes without any effective operation on display panel 172, the screen image display on display panel 172 returns to the initial screen image (standby screen image).

At step 404, CPU 180 determines whether or not green cross key 362 is pressed. When green cross key 362 is pressed, CPU 180 obtains the current time from the timer and sets the time as the start time (for example, overwrites the prescribed area of RAM 184 where the start time was stored at step 402). Thereafter, the control returns to step 406. If the key is not pressed, the control proceeds to step 412.

The process at step 412 is the same as the flowchart shown in FIG. 19. Therefore, after red cross key 360 is pressed (more specifically, from the start time set at step 402), CPU 180 waits for the next key operation for a prescribed time period (reference time). If the prescribed time period passes without any effective operation on display panel 172, the screen image display on display panel 172 returns to the initial screen image.

At step 406, CPU 180 determines whether or not blue cross key 364 is pressed. If blue cross key 364 is pressed, the control proceeds to step 408, and the special mode is entered. If blue cross key 364 is not pressed, the control proceeds to step 414. The process at step 414 is the same as the flowchart shown in FIG. 19. Therefore, after green cross key 362 is pressed (more specifically, from the start time set at step 404), CPU 180 waits for the next key operation for a prescribed time period (reference time). If the prescribed time period passes without any effective operation on display panel 172, the screen image display on display panel 172 returns to the initial screen image.

Through the process described above, transition to the special mode can be made only when the cross keys of three colors are pressed in a prescribed order in the first screen image (FIG. 16 or 17), which is displayed when program key 228 of information input device 166 is pressed in a manner different from the normal manner. The cross keys displayed at the corners of screen image are generally not recognized as function keys. Therefore, it is possible to prevent a general user from easily entering the special mode.

Further, by appropriately changing the positions of displaying the cross keys of three colors, the order of pressing three cross keys changes. Therefore, easy entrance to the special mode by a general user can more reliably be prevented. Further, even if the cross display areas are known to be function keys, the display positions of the cross keys of three colors are changed appropriately and, hence, the order of positions pressed on the display panel 172 is also changed. Therefore, it is possible to prevent a general user from easily entering the special mode.

If the cross keys of three colors are pressed in a prescribed order, the password input image (FIG. 9) may be displayed and transition to the special mode may be made if the authentication is successful, without directly entering the special mode. If such an approach is taken, it is possible to more reliably prevent a general user from entering the special mode.

In the foregoing, an example has been described in which crosses are displayed at the corners of the screen image. The example above, however, is not limiting. Any characters, signs or symbols generally not recognized as keys, having mutually different colors may be used. Figures that may be recognized as simple design are desirable. Further, the colors of figures and the like displayed at the corners may be any three different colors, and not limited to red, green and blue.

### Third Embodiment

A third embodiment for displaying a screen image for entering the special mode in image processing apparatus 150 will be described in the following.

<Exemplary Screen Image Display on Display Panel>

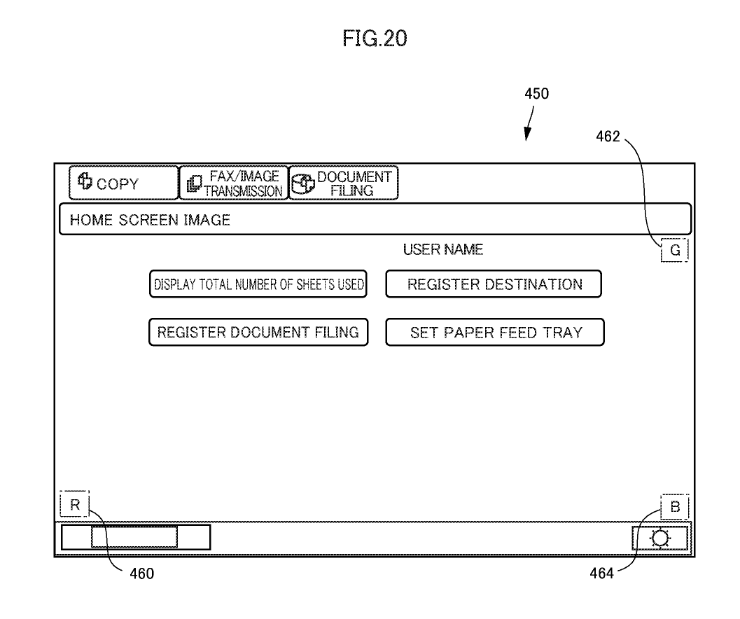

FIG. 20 shows a third example of the screen image displayed on display panel 172 when program key 228 is pressed in a manner different from the normal manner, in information input device 166 shown in FIG. 5. Though a screen image 450 of FIG. 20 is similar to screen image 240 shown in FIG. 7, in place of date and time, letters R, G and B are shown at three corners. Function keys such as “display total number of sheets used” shown in FIG. 20 are the same as those of FIG. 7 and, therefore, description thereof will not be repeated.

The letters R, G and B shown at the corners of the screen image may be of the same color or different colors. By way of example, the letter R on the lower left corner may be red, the letter G at the upper right corner may be green, and the letter B at the lower right corner may be blue. Only when the areas where these letters R, G and B are displayed (hereinafter referred to as R key 460, G key 462 and B key 464) are pressed successively in a prescribed order, the password input screen image (see FIG. 9) is displayed and if the authentication is successful, the special screen image is displayed and the special mode is entered.

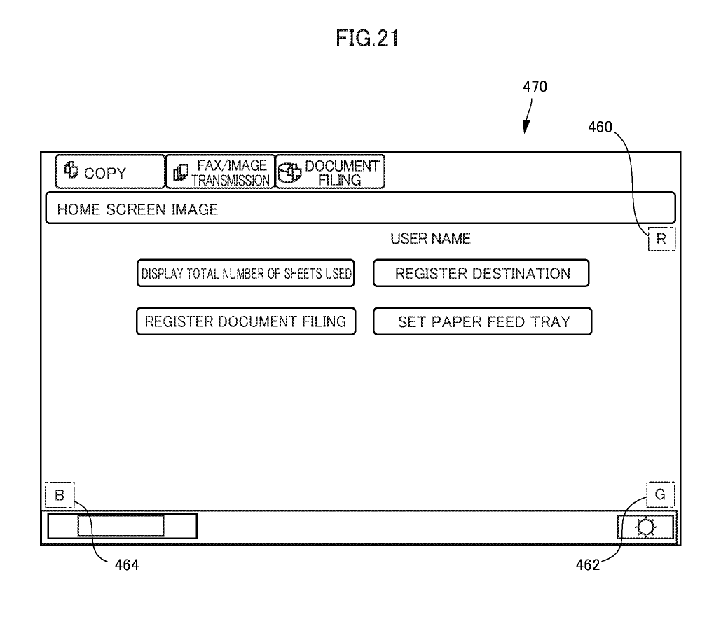

FIG. 21 shows a screen image 470 displayed on display panel 172 when program key 228 is pressed in a manner different from the normal manner. Though screen image 470 is similar to screen image 450 shown in FIG. 20, the arrangement of R key 460, G key 462 and B key 464 displayed at three portions is different from that of FIG. 20. In FIG. 21, B key 464 is shown at the lower left corner, R key 460 is shown at the upper right corner, and G key 462 is shown at the lower right corner. As in FIG. 20, only when R key 460, G key 462 and B key 464 are pressed successively in a prescribed order, the password input screen image allowing transition to the special mode is displayed.

When program key 228 is pressed in a manner different from the normal manner, the same screen image may be displayed. In the present embodiment, however, the arrangement of R key 460, G key 462 and B key 464 is changed in accordance with the situation of pressing the program key 228 (for example, date and time of pressing), or at random. Even in that case, however, the conditions for entering the special mode, that is, the order in which R key 460, G key 462 and B key 464 are to be pressed successively, are kept unchanged.

<Third Software Configuration>

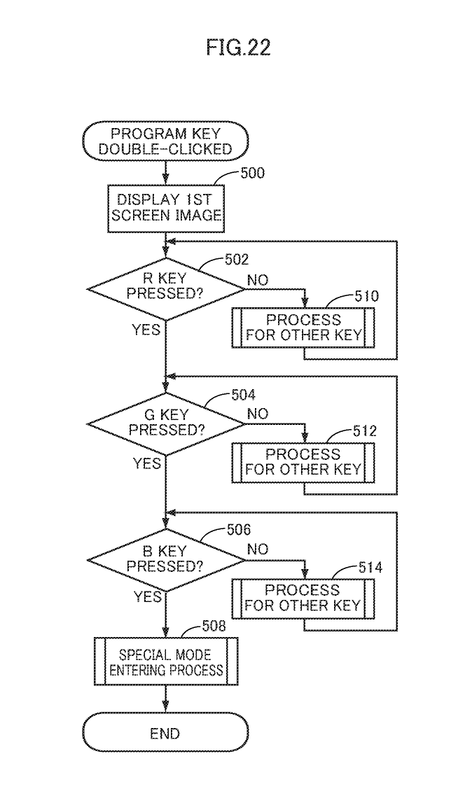

Referring to FIG. 22, when program key 228 is pressed in a manner different from the normal manner (double-clicked), at step 500 of the program for realizing the process for displaying the special screen image, CPU 180 displays the first screen image on display panel 172. The first screen image is screen image 450 or 470 shown in FIG. 20 or 21. Here, in order to resume the standby screen image (see FIG. 5) if the display of screen image continues for a prescribed time period or longer as will be described later, CPU 180 obtains the current time from a timer and sets the time as a start time (for example, stores the current time in a prescribed area secured in advance in RAM 184).

At step 502, CPU 180 determines whether or not R key 460 is pressed. If R key 460 is pressed, CPU 180 obtains the current time from the timer and sets the time as the start time (for example, overwrites the prescribed area of RAM 184 where the start time was stored at step 500). Thereafter, the control proceeds to step 504. If R key 460 is not pressed, the control proceeds to step 510.

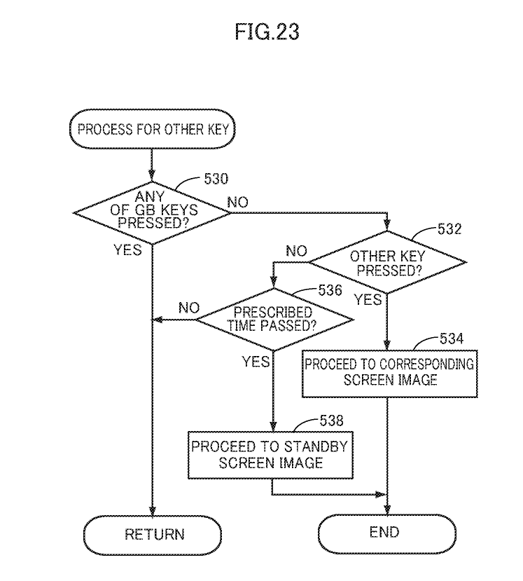

The process at step 510 is as shown in FIG. 23. Specifically, at step 530, CPU 180 determines whether or not either of G key 462 and B key 464 is pressed. If either of G key 462 and B key 464 is pressed, the control returns to step 502. If neither of the keys is pressed, the control proceeds to step 532. At step 532, CPU 180 determines whether or not any key (function key) other than R key 460, G key 462 and B key 464 is pressed. If any of the function keys is pressed, at step 534, CPU 180 displays a screen image corresponding to the pressed key, and the present program ends. If none of the function keys is pressed, at step 536, CPU 180 obtains the current time, and calculates the elapsed time from the start time set at step 500. CPU 180 determines whether or not the calculated elapsed time is equal to or longer than a preset reference time. If it is equal to or longer than the reference time, the control proceeds to step 538, at which CPU 180 displays the standby screen image, and the present program ends. If it is shorter than the reference time, the control returns to step 502. Therefore, CPU 180 waits for pressing of R key 460 for a prescribed time period (reference time) after the first screen image is displayed. If the prescribed time period passes without any effective operation on display panel 172, the screen image display on display panel 172 returns to the initial screen image.

At step 504, CPU 180 determines whether or not G key 462 is pressed. If G key 462 is pressed, CPU 180 obtains the current time from the timer and sets the time as the start time (for example, overwrites the prescribed area of RAM 184 where the start time was stored at step 502). Thereafter, the control returns to step 506. If G key 462 is not pressed, the control proceeds to step 512. The process at step 512 is the same as the flowchart shown in FIG. 23. Specifically, what is different is that at step 530 of FIG. 23, determination is made as to whether B key 464 or R key 460 is pressed, and that the control returns to step 504. Therefore, accumulative description will not be repeated. At step 512, CPU 180 waits for pressing of G key 462 for a prescribed time period (reference time) after R key 460 is pressed (specifically, from the start time set at step 502). If the prescribed time period passes without any effective operation on display panel 172, the screen image display on display panel 172 returns to the initial screen image.

At step 506, CPU 180 determines whether or not B key 464 is pressed. If B key 464 is pressed, the control proceeds to step 508. If B key 464 is not pressed, the control proceeds to step 514. The process at step 514 is the same as the flowchart shown in FIG. 23. Specifically, what is different is that at step 530 of FIG. 23, determination is made as to whether R key 460 or G key 462 is pressed, and that the control returns to step 506. Therefore, accumulative description will not be repeated. At step 514, CPU 180 waits for pressing of B key 464 for a prescribed time period (reference time) after G key 462 is pressed (specifically, from the start time set at step 504). If the prescribed time period passes without any effective operation on display panel 172, the screen image display on display panel 172 returns to the initial screen image.

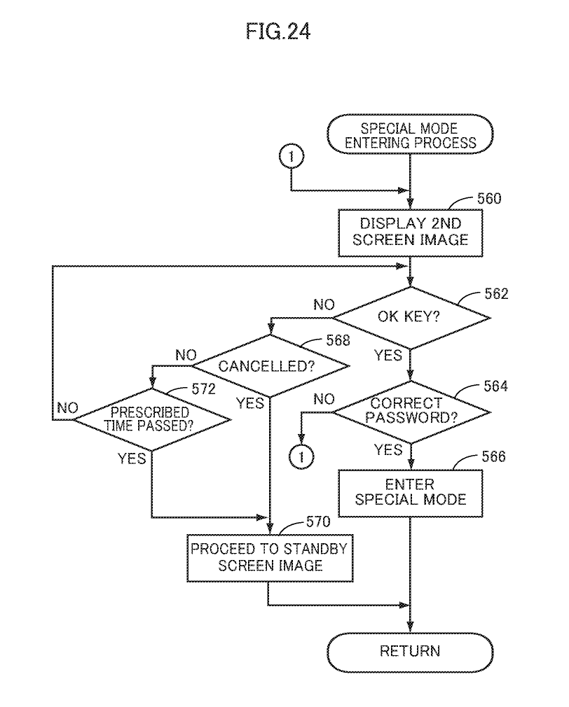

The process at step 508 is as shown in FIG. 24. At step 560, CPU 180 displays the second screen image, and obtains the current time from the timer and sets the time as the start time (for example, overwrites the prescribed area of RAM 184 at which the start time was stored at step 504). The second screen image is password input screen image shown in FIG. 9.

At step 562, CPU 180 determines whether or not OK key 266 is pressed. If OK key 266 is pressed, the control proceeds to step 564. If OK key 266 is not pressed, the control proceeds to step 568.

At step 564, CPU 180 determines whether or not a correct password is input. If the password is correct, at step 566, image processing apparatus 150 enters the special mode. Specifically, CPU 180 displays the special screen image on display panel 172 and activates the program for the special mode, and terminates the present program. If the password is not correct, the control returns to step 560, and CPU 180 again receives a password input. At the time when the control returns to step 560, CPU 180 displays, for example, a message that the password is not correct.

At step 568, CPU 180 determines whether or not cancel key 264 is pressed. If cancel key 264 is pressed, the control proceeds to step 570, at which CPU 180 displays the standby screen image, and the present program ends. If cancel key 264 is not pressed, the control proceeds to step 572, CPU 180 calculates the elapsed time from the start time set at step 560, and determines whether or not the prescribed time period has passed. If the prescribed time period has not yet passed, the control returns to step 562. If the prescribed time period has passed, the control proceeds to step 570 at which CPU 180 displays the standby screen image, and the present program ends.

Through the process described above, transition to the special mode can be made only when R key 460, G key 462 and B key 464 are pressed in a prescribed order in the first screen image (FIG. 20 or 21), which is displayed when program key 228 of information input device 166 is pressed in a manner different from the normal manner. The letters R, G and B displayed at the corners of screen image are generally not recognized as function keys. Therefore, it is possible to prevent a general user from easily entering the special mode. Further, by appropriately changing the positions of displaying R key 460, G key 462 and B key 464, the order of pressing these three keys changes. Therefore, easy entrance to the special mode by a general user can more reliably be prevented. Further, even if the letters R, G and B are known to be function keys, the display positions of R key 460, G key 462 and B key 464 are changed appropriately and, hence, the order of positions pressed on the display panel 172 is also changed. Therefore, it is possible to prevent a general user from easily entering the special mode.

When R key 460, G key 462 and B key 464 are successively pressed in a prescribed order, at step 508, the special screen image may be directly displayed as the second screen image, without displaying password input screen image 260.

In the foregoing, an example has been described in which the first screen image (screen image 450 of FIG. 20 or screen image 470 of FIG. 21) is displayed when program key 228 is pressed in a manner different from the normal manner and by prescribed key operations on the first screen image, the transition to the special mode is made directly, or through password input screen image 260. When the first screen image is displayed, whether or not the special mode entering function is to be enabled or disabled may be set. For instance, as in the first embodiment, the special mode entering function may be enabled or disabled depending on the manner how program key 228 is pressed. For example, whether the special mode entering function is to be enabled/disabled may be set depending on whether program key 228 is long-pressed or double-clicked. Specifically, if program key 228 is long-pressed, the first screen image may be displayed with the special mode entering function disabled, and if program key 228 is double-clicked, the first screen image may be displayed with the special function entering function enabled. The conditions for enabling/disabling may be reversed.

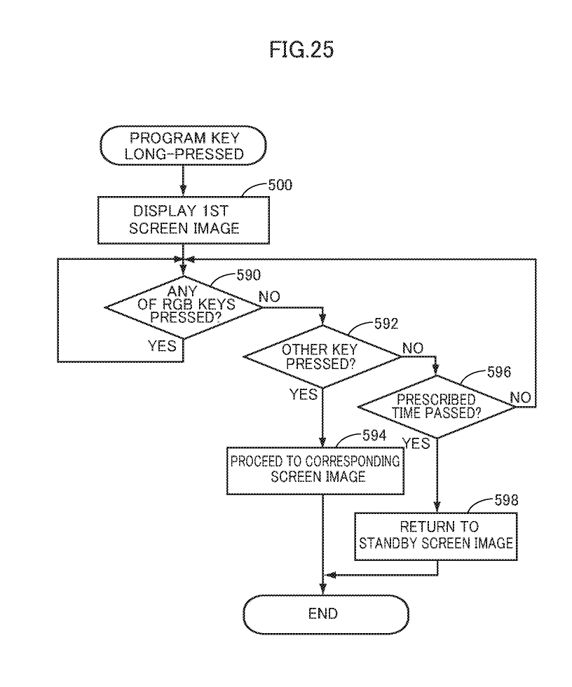

Referring to FIG. 25, if program key 228 is long-pressed, at step 500 of the program executing the process for displaying the first screen image with the special mode entering function disabled, CPU 180 displays the first screen image on display panel 172. The first screen image is screen image 450 or 470 shown in FIG. 20 or 21. Here, in order to resume the standby screen image (see FIG. 5) if the display of screen image continues for a prescribed time period or longer, CPU 180 obtains the current time from a timer and sets the time as a start time (for example, stores the current time in a prescribed area secured in advance in RAM 184).

At step 590, CPU 180 determines whether any of R key 460, G key 462 and B key 464 is pressed, at a prescribed time interval. If any of R key 460, G key 462 and B key 464 is pressed, CPU 180 again makes the determination at step 590 without any other operation. If none of R key 460, G key 462 and B key 464 is pressed, the control proceeds to step 592.

At step 592, CPU 180 determines whether or not any key (function key) other than R key 460, G key 462 and B key 464 is pressed. If any function key is pressed, the control proceeds to step 594. At step 594, CPU 180 displays a screen image corresponding to the pressed function key, and the present program ends. If none of the function keys is pressed, at step 596, CPU 180 obtains the current time, and calculates the elapsed time from the start time set at step 500. CPU 180 determines whether or not the calculated elapsed time is equal to or longer than a preset reference time. If it is equal to or longer than the reference time, the control proceeds to step 598, at which CPU 180 displays the standby screen image, and the present program ends. If it is shorter than the reference time, the control returns to step 590.

Therefore, after the first screen image is displayed, CPU 180 waits for pressing of a function key for the prescribed time period (reference time). If any of R key 460, G key 462 and B key 464 is simply pressed and the prescribed time period passes without any effective operation on display panel 172, the screen image on display panel 172 returns to the initial screen image.

In the second embodiment also, the special mode entering function may be enabled/disabled depending on the manner how program key 228 is pressed, similar to the above.

In the foregoing, an example has been described in which the first screen image is displayed if the program key is pressed in a manner (including long-press and double click) different from the normal manner. The operation conditions to display the first screen image may be determined arbitrarily. By way of example, the first screen image may be displayed if program key 228 is successively pressed three times or more with a short time interval, or the first screen image may be displayed while program key 228 is pressed and held.

Further, the operation as a trigger for displaying the first screen image may be an operation on a soft key displayed on the display panel, rather than the operation on a hard key arranged on the operation panel.

Further, in the first embodiment, the operation on date and time display area 242 for invoking display of the second screen image 260 may be any operation. By way of example, the second screen image 260 may be displayed if the area is long-pressed or double-clicked.

Further, in the second and third embodiments, the number and positions of the figures and the like displayed on the first screen image may be arbitrary determined. The figures and the like may be displayed at all four corners, or may be displayed at positions other than the corners.

Further, the information input device may be formed to include at least one hard key and a display panel that allows touch-input. Alternatively, the information input device may be formed only of a display panel that allows touch input.

Further, it is possible to display the first screen image only when a prescribed hard key is long-pressed, and to display the second screen image if a prescribed area (such as date and time display area) for invoking display of the second area is pressed while the state is maintained. In such an approach, even if the prescribed hard key is long-pressed and the first screen image is once displayed, the first screen image disappears and the original image is resumed once pressing of the hard key is released. Therefore, such an approach requires simultaneous use of two fingers (of one hand or two hands). This further reduces the possibility that the special screen image is easily or inadvertently displayed. The operation made on the first screen image to display the second screen image may be any of the operations described with reference to the first to third embodiments.

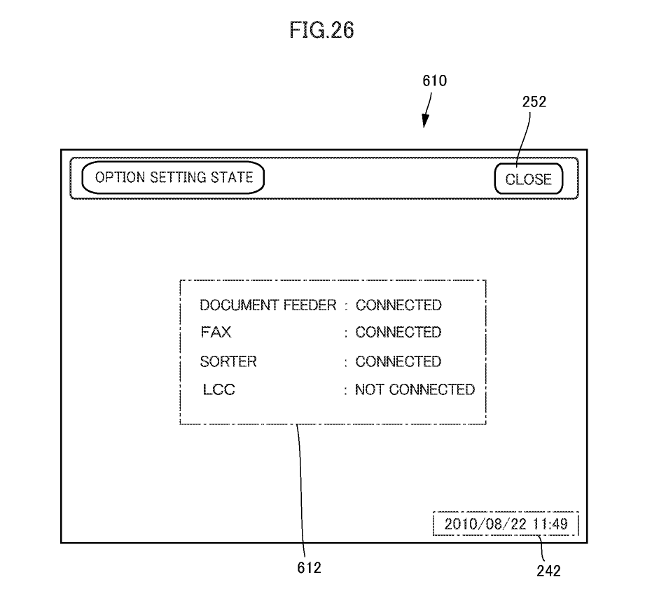

Though an example in which a screen image that requests a selection (FIGS. 7, 16, 17, 20 and 21) is displayed as the first screen image, it is not limiting. The first screen image may be a screen image that does not request a selection by the user such as an image 610 shown in FIG. 26, that is, a screen image not requesting any operation at all. Screen image 610 includes an area displaying information related to image processing apparatus 150, and an area for invoking display of the second screen image when pressed.

“Requests a selection” means that the display requests the user to press a specific portion on the screen image. Specifically, “requests a selection” means that the display causes the user to expect that a different screen image would appear, particularly, a screen image allowing setting of the image processing apparatus would appear, if the portion is pressed, or to have the user easily understand such a development. Further, “does not request a selection” means that the display does not request the user to press a specific portion on the screen image. Specifically, “does not request a selection” means that the display causes the user to expect that nothing would be newly displayed, particularly, the screen image for setting the image processing apparatus would not be opened, even if the portion is pressed, or to have the user easily understand such a development. Therefore, “information that requests a selection” means a piece of information that causes the user to expect that another screen image (particularly, the screen image allowing setting of the image processing apparatus) would open if the portion displaying the information is pressed, or to have the user easily understand such a development. Further, “information that does not request a selection” means a piece of information that causes the user to expect that nothing would be displayed (particularly, the setting related to the image processing apparatus would not be allowed) even if the portion displaying the information is pressed, or to have the user easily understand such a development. Specifically, the user does not think of pressing the display area even when he/she looks at the “information that does not request a selection.”

Screen image 610 of FIG. 26 includes date and time display area 242 as the area invoking display of the second screen image when pressed, while specific information display area 612 does not include any display (“display total number of sheets used,” “register destination,” “register document filing” or “set paper feed tray”) that requests a selection, different from the example of FIG. 7. Here, the “specific information” means a piece of information directly related to the image processing apparatus. On specific information display area 612, state of connection of optional devices connectable to the body of image processing apparatus is displayed as information directly related to the image processing apparatus. “Document feeder” represents a device for automatically feeding a document set on a tray. “FAX” represents an internal circuit board for facsimile transmission. “Sorter” represents a post-processing device for sorting sheets of printed paper discharged to discharge trays to a designated order. “LCC” represents a large capacity cassette that can contain larger number of sheets of recording paper than a common cassette. The screen image 610 represents information that the document feeder, FAX and sorter are connected, while LCC is not connected, to the image processing apparatus.

Specific information display area 612 and date and time display area 242 of screen image 610 display pieces of information that do not request a selection. Therefore, what the user is expected to do is to simply look at the information. Therefore, the possibility that the special mode is activated by the user touching the display can be reduced, and easy change of setting of the image processing apparatus by the user can be prevented. The information displayed in the area for invoking display of the second screen image when pressed is not limited to text information, and it may be any information including at least one of characters, signs and figures.

Further, it is preferred that pieces of information of different types are displayed on the area displaying the information of image processing apparatus and the area for invoking display of the second screen image when pressed. Since the information displayed on specific information display area 612 and the information displayed on the area (date and time display area 242) for invoking display of the second screen image when pressed are of different types, the user simply reads the plurality of pieces of displayed information and does not think of touching the displayed information.

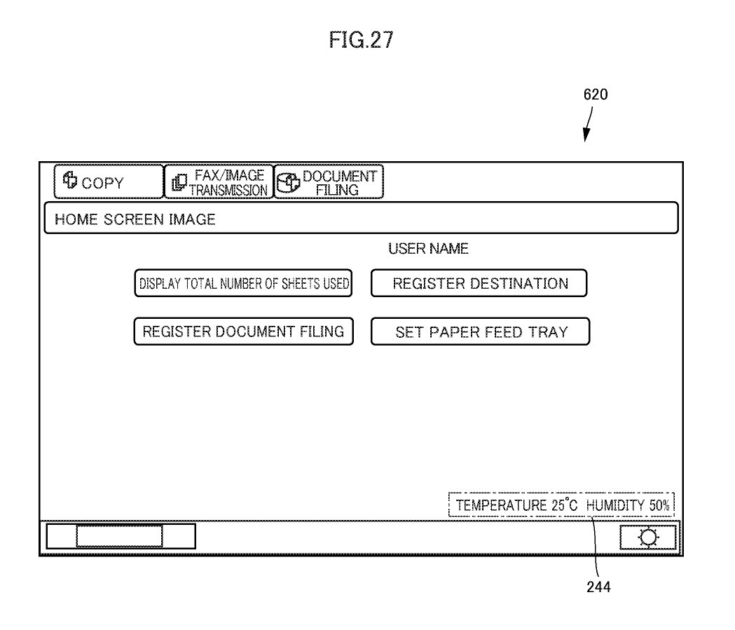

In the first embodiment, an example has been described in which the second screen image 260 is displayed when date and time display area 242 on the first screen image 240 is pressed. The example, however, is not limiting. The information displayed on the date and time display area may be one of, or any combination of year, month, date, day of the week and time information. Further, the area for invoking display of the second screen image when pressed may have display other than the date and time. Specifically, on this area, display not including any information requesting or suggesting any instruction to the image processing apparatus when pressed, and not requesting any operation, should be given. By way of example, general information not directly related to the image processing apparatus may be displayed in this area, as shown in FIGS. 27 to 29.

A screen image 620 shown in FIG. 27 is similar to screen image 240 of FIG. 7. What is different is that at the lower right corner area (the area for invoking display of the second screen image 260 when pressed), information other than date and time is displayed. Specifically, on general information display area 244, temperature and humidity around the image processing apparatus which are detected by a temperature sensor and a humidity sensor provided in the image processing apparatus are displayed. The detected values of temperature sensor and humidity sensor are not used for controlling the image processing apparatus. These pieces of information are not directly related to the image processing apparatus and not changeable by the user. Therefore, the user does not think of pressing general information display area 244.

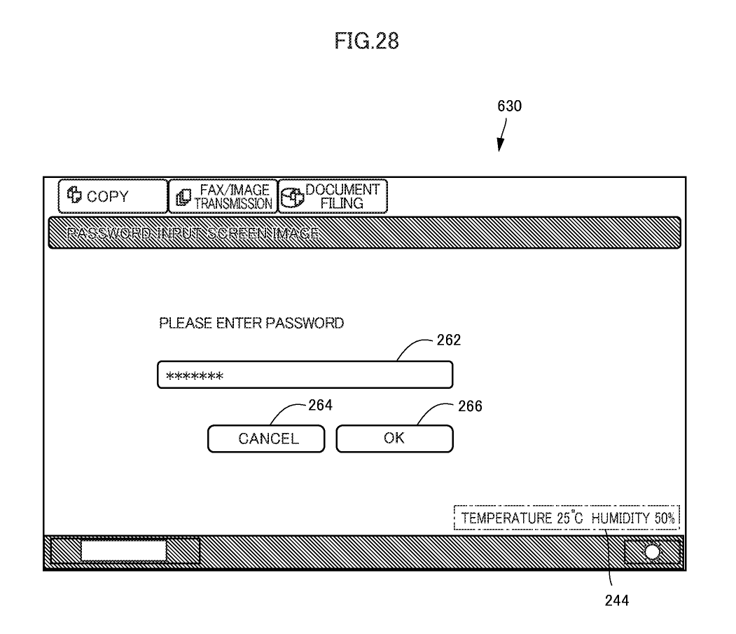

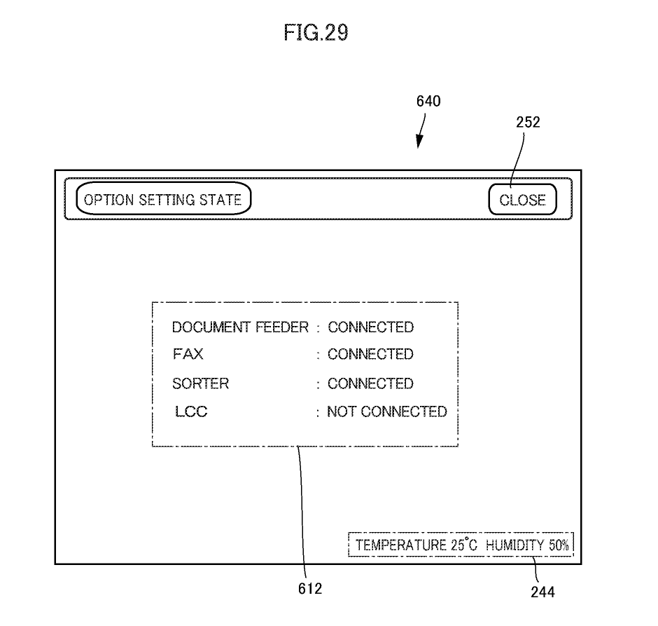

A screen image 630 shown in FIG. 28 is similar to screen image 260 of FIG. 9. What is different is that at the general information display area 244 at the lower right corner (the area for invoking display of the second screen image 260 when pressed), temperature and humidity around the image processing apparatus are displayed. Similarly, a screen image shown in FIG. 29 is similar to screen image 610 of FIG. 26. At the general information display area 244 at the lower right corner (the area for invoking display of the second screen image 260 when pressed), temperature and humidity around the image processing apparatus are displayed.

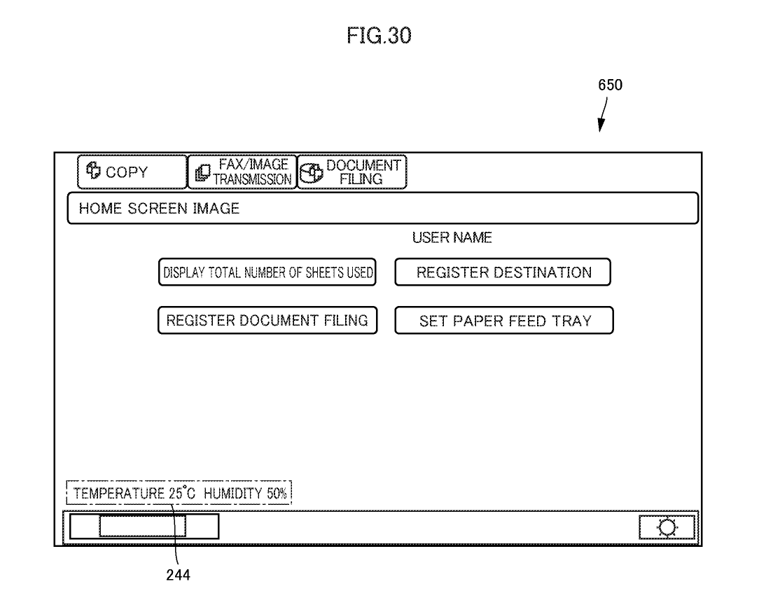

Further, the position of displaying general information display area 244 is not limited to the lower right corner of the screen image. By way of example, general information display area 244 may be displayed at the lower left corner of a screen image 650, as shown in FIG. 30.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

What is claimed is:

1. An information input device, comprising:
a display unit that has a display screen and displays an image on said display screen;
an input unit that is arranged on said display screen and specifies a designated position on said display screen; and
a display control unit that controls said display unit to display any of first, second and third screen images depending on a state of said information input device; wherein
said first and third screen images both have a prescribed area displaying information including the same character, sign or figure, displayed in a predetermined size at a predetermined position;
said display unit displays said first or third screen image when a prescribed key is pressed; and
said display control unit controls said display unit to display said second screen image when a position in said prescribed area is specified by said input unit while said first screen image is being displayed, and
maintains display of said third screen image when a position in said prescribed area is specified by said input unit while said third screen image is being displayed.

2. The information input device according to claim 1, wherein said first and third screen images have identical appearance.

3. The information input device according to claim 1, wherein said prescribed area does not include information representing said second screen image.

4. The information input device according to claim 1, wherein the information in said prescribed area includes at least one piece of information selected from the group consisting of year, month, date, day of the week and time.

5. The information input device according to claim 1, wherein the information in said prescribed area includes information of at least one of temperature and humidity.

6. The information input device according to claim 1, wherein said first screen image further includes information of at least one of character, sign and figure suggesting display of a fourth screen image.

7. The information input device according to claim 6, connected to an image processing apparatus, wherein
said fourth screen image is a screen image displaying information representing state of said image processing apparatus.

8. The information input device according to claim 1, connected to an image processing apparatus, wherein
said second screen image is a password input screen image, or a special image for setting or testing said image processing apparatus.

9. The information input device according to claim 1, connected to an image processing apparatus, wherein
said second screen image is a password input screen image; and
if authentication is successfully passed using said password input screen image, said display unit displays a special screen image for setting or testing said image processing apparatus.

10. The information input device according to claim 9, wherein information suggesting transition to said special screen image is not displayed in said prescribed area.

11. The information input device according to claim 1, wherein said prescribed area is positioned at a corner of said first screen image.

12. The information input device according to claim 1, wherein said display unit displays said first screen image when said prescribed key is pressed in a predetermined and prescribed manner.

13. The information input device according to claim 12, wherein said prescribed manner is long-pressing said prescribed key, or successively pressing said prescribed key for a plurality of times.

14. The information input device according to claim 1, wherein
when said prescribed key is pressed in a first manner of pressing, said display unit displays said first screen image; and
when said prescribed key is pressed in a second manner of pressing different from said first manner of pressing, said display unit displays said third screen image.

15. The information input device according to claim 14, wherein
said first manner of pressing is either one of long-pressing and successive pressing of successively pressing the same key for a plurality of times; and
said second manner of pressing is the other one of said long-pressing and said successive pressing.

16. The information input device according to claim 1, wherein said prescribed key is a hard key provided separate from said input unit, or a soft key configured by a partial image displayed on said display unit and that area of said input unit which corresponds to said partial image.

17. The information input device according to claim 1, wherein
said prescribed key is a hard key provided separate from said input unit; and
said display unit displays said first screen image only while said prescribed key is long-pressed.

18. The information input device according to claim 1, connected to an image processing apparatus and further comprising an operation unit receiving an input of a user operating said image processing apparatus; wherein
said input unit and said prescribed key constitute said operation unit;
said input unit is a touch-panel; and
said prescribed key is a hard key.

19. An image processing apparatus, comprising
the information input device according to claim 1, and
receiving a user operation through said information input device.

20. A method of controlling an information input device that includes a display unit that has a display screen and displays an image on said display screen, and an input unit that is arranged on said display screen and specifies a designated position on said display screen, comprising the steps of:
controlling said display unit to display any of first, second and third screen images depending on state of said information input device; and
displaying said first or third screen image when a prescribed key is pressed; wherein
said first and third screen images both have a prescribed area displaying information including the same character, sign or figure, displayed in a predetermined size at a predetermined position;
said method further comprising the steps of:
displaying said second screen image when a position in said prescribed area is specified by said input unit while said first screen image is being displayed; and
maintaining display of said third screen image when a position in said prescribed area is specified by said input unit while said third screen image is being displayed.
